(19) United States
(12) Patent Application Publication
(10) Pub. No.: US 2014/0074475 A1
(43) Pub. Date: Mar. 13, 2014

(54) SPEECH RECOGNITION RESULT SHAPING APPARATUS, SPEECH RECOGNITION RESULT SHAPING METHOD, AND NON-TRANSITORY STORAGE MEDIUM STORING PROGRAM

(71) Applicants: Tasuku Kitade, Tokyo (JP); Kiyokazu Miki, Tokyo (JP)

(72) Inventors: Tasuku Kitade, Tokyo (JP); Kiyokazu Miki, Tokyo (JP)

(73) Assignee: NEC Corporation, Tokyo (JP)

(21) Appl. No.: 14/008,752

(22) PCT Filed: Nov. 29, 2011
(86) PCT No.: PCT/JP2011/006627

§ 371 Date: Sep. 30, 2013

(30) Foreign Application Priority Data
Mar. 30, 2011 (JP) 2011-075257

(51) Int. Cl. G10L 15/01

(52) U.S. Cl. CPC G10L 15/01
USPC 704/251

(57) ABSTRACT

There is provided a speech recognition result forming apparatus (10) including a recognition result output unit (106) that refers to character string data, which is a speech recognition result, and removes a word string of a recognition error included in the character string data from the character string data and also, when attached word strings are located before and/or after the word string of the recognition error, generates preformatted character string data by removing at least one of the attached word strings from the character string data or replacing at least one of the attached word strings with other data items and outputs the preformatted character string data.

### TECHNICAL FIELD

The present invention relates to a speech recognition result forming apparatus, a speech recognition result forming method, and a program.

### BACKGROUND ART

A recognition error may be included in the speech recognition result. Since a sentence containing such a recognition error may not make sense, a technique for solving the inconvenience is required.

Patent Document 1 discloses a speech recognition apparatus including a speech recognition unit, a GWPP calculation processing unit, a word removal unit, a threshold value storage unit, and a re-scoring unit.

The speech recognition apparatus operates as follows. That is, the speech recognition unit performs speech recognition using a statistical method that uses the acoustic model and the language model, and outputs a predetermined number of hypotheses. The GWPP calculation processing unit calculates the confidence measure for speech recognition for each word included in each of the N hypotheses transmitted from the speech recognition unit, gives the calculated value to each word, and outputs the result to the word removal unit. When the value of the confidence measure for speech recognition given to each word in the N hypotheses is lower than the threshold value stored in the threshold storage unit, the word removal unit removes the word from the hypotheses. The threshold storage unit stores a threshold value referred to when removing a word. The re-scoring unit calculates a product of the confidence measure for speech recognition for each word for each of the N hypotheses transmitted from the word removal unit, and outputs a hypothesis with a largest value of the products.

Patent Document 2 discloses a method for correcting a recognition error section in speech recognition that includes: a first step of detecting a recognition error section from a recognition result sentence recognized by a speech recognition apparatus; a second step of searching for an example sentence similar to the recognition result sentence, in which the recognition error section has been detected in the first step, from the example corpus prepared in advance and extracting the alternatives corresponding to the recognition error section from each of the searched example sentences; and a third step of selecting the best candidate from the alternatives extracted in the second step.

Patent Document 3 discloses a language processing apparatus that outputs an argument structure for a predicate or an action noun in the input text and is characterized in that it includes: a case conversion rule storage unit that stores a rule to convert a modification state between a predicate or an action noun and a word or word attributes other than the predicate or the action noun into a case relation between the predicate or the action noun and the word other than the predicate or the action noun; and a case conversion unit that converts input text into the argument structure of the predicate and the action noun by applying the modification state of the text and the rule for conversion into the case relation stored in the case conversion rule storage unit and outputs the result.

Patent Document 4 discloses a word correction method of an apparatus that automatically corrects the expression of a word in a Japanese character string, the apparatus including a unit that stores the information of a word that a document creating person wants to correct, a unit that registers this correction information, a unit that stores information required for correction for basic terms, such as an ending or an auxiliary verb, a unit that performs word segmentation and recognition of the use of part of speech for the input Japanese document using a Japanese word dictionary, a unit that detects a word to be corrected that has been designated by the correction information storage unit, and a unit that corrects a word. In this method of correcting a word in a Japanese document, a document creating person designates a word to be corrected and a replacement word in advance using the correction information storage unit, stores an index according to the use of part of speech after replacement in a basic term correction information storage unit for attached words, such as endings or auxiliary verbs, checks the result of the word segmentation and the recognition of the use of part of speech, which have been performed by the unit for word segmentation and recognition of use of part of speech, and the word to be corrected and detects a matching section, and replaces the word to be corrected with a replacement word for the detected section and also replaces an attached word associated with the word to be corrected by performing searching using the basic term correction information storage unit.

### RELATED DOCUMENT

### Patent Document

[Patent Document 1] Japanese Unexamined Patent Publication No. 2008-58503
[Patent Document 2] Japanese Unexamined Patent Publication No. 2003-308094
[Patent Document 3] Japanese Unexamined Patent Publication No. 2009-176168
[Patent Document 4] Japanese Unexamined Patent Publication No. 4-199359

### Non-Patent Document

[Non-patent Document 1] J. Lafferty, A. McCallum, and F. Pereira. Conditional random fields: Probabilistic models for segmenting and labeling sequence data, In Proc. Of ICML, pp. 282-289, 2001.

### DISCLOSURE OF THE INVENTION

In the speech recognition apparatus disclosed in Patent Document 1, the word removal unit determines whether to remove each word of the hypothesis, which is acquired by speech recognition, in units of a word on the basis of the confidence measure for speech recognition, the re-scoring unit re-scores the hypothesis from which a word has been removed, and a hypothesis of the maximum likelihood is selected and output. For this reason, a word itself, which is determined to be an error on the basis of the confidence measure for speech recognition, or one entire hypothesis is removed. Accordingly, a hypothesis eventually output from the re-scoring unit is also a sentence obtained by removing only the word, which has been determined to be a recognition error on the basis of the confidence measure for speech recognition, from the original recognition result. Due to the removal of the word, an unnatural Japanese sentence, such as continuous attached words, may be generated, or a sentence that does not make sense may be generated.

In addition, in the word correction method disclosed in Patent Document 4, a replacement word is detected from the input sentence with reference to correction information which designates a word to be corrected in advance. In addition, the same processing is performed on the same word included in the input sentence. Thus, in the case of the technique disclosed in Patent Document 4, since the width of the contents of the correction becomes narrow, sufficient correction cannot be performed. In the techniques disclosed in Patent Documents 2 and 3, it cannot be said that the contents of the correction are sufficient.

Therefore, it is an object of the present invention to provide means for appropriately forming character string data that is a speech recognition result.

According to the present invention, there is provided a speech recognition result forming apparatus including a recognition result output unit that refers to character string data, which is a speech recognition result, and removes a word string of a recognition error included in the character string data from the character string data and also, when attached word strings are located before and/or after the word string of the recognition error, generates preformatted character string data by removing at least one of the attached word strings from the character string data or replacing at least one of the attached word strings with other data items and outputs the preformatted character string data.

In addition, according to the present invention, there is provided a program causing a computer to function as a recognition result output unit that refers to character string data, which is a speech recognition result, and removes a word string of a recognition error included in the character string data from the character string data and also, when attached word strings are located before and/or after the word string of the recognition error, generates preformatted character string data by removing at least one of the attached word strings from the character string data or replacing at least one of the attached word strings with other data items and outputs the preformatted character string data.

In addition, according to the present invention, there is provided a speech recognition result forming method including causing a computer to execute processing for referring to character string data, which is a speech recognition result, and removing a word string of a recognition error included in the character string data from the character string data and also, when attached word strings are located before and/or after the word string of the recognition error, generating preformatted character string data by removing at least one of the attached word strings from the character string data or replacing at least one of the attached word strings with other data items and outputting the preformatted character string data.

In addition, according to the present invention, there is provided a speech recognition result forming apparatus including: a conversion word determination unit that refers to recognition result data, which is character string data that is a speech recognition result and is divided into word strings and in which recognition result confidence measure for speech recognition is given to each word string, and that determines a low confidence measure word string to be removed from the character string data on the basis of the recognition result confidence measure for speech recognition and also determines whether word strings whose removal is to be considered, which are word strings located before and after the low confidence measure word string, are to be removed from the character string data or replaced with other data items on the basis of the recognition result confidence measure for speech recognition; and a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

In addition, according to the present invention, there is provided a speech recognition result forming apparatus including: a word dependence calculation unit that refers to recognition result data, which is character string data that is a speech recognition result and is divided into word strings and in which recognition result confidence measure for speech recognition is given to each word string, and that divides the character string data into phrases and determines a modification relation of each of the phrases to other phrases; a conversion word determination unit that refers to the recognition result data and that determines a low confidence measure word string to be removed from the character string data and a phrase including the low confidence measure word string to be removed from the character string data on the basis of the recognition result confidence measure for speech recognition and also determines a phrase modified by the phrase to be removed from the character string data or replaced with other data items on the basis of the recognition result confidence measure for speech recognition; and a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

According to the present invention, it is possible to appropriately form character string data that is a speech recognition result.

### BRIEF DESCRIPTION OF THE DRAWINGS

The above-described object and other objects, features, and advantages will become more apparent by preferred embodiments described below and the following accompanying drawings.

FIG. 1 is an example of a functional block diagram of a speech recognition result forming apparatus of the present embodiment.

FIG. 2 is a flow chart showing an example of the flow of the process of a speech recognition result forming method of the present embodiment.

FIG. 3 is a diagram for explaining the operations and effects of the present embodiment.

FIG. 4 is a diagram for explaining the operations and effects of the present embodiment.

### DESCRIPTION OF EMBODIMENTS

Hereinafter, an embodiment of the present invention will be described with reference to the drawings.

In addition, each unit of the present embodiment is realized by any combination of hardware and software based on a CPU and a memory of an arbitrary computer, a program loaded into the memory (including not only a program stored in the memory in advance from the step of shipping the apparatus but also a program downloaded from storage media such as a CD, a server on the Internet, or the like), a storage unit such as a hard disk that stores the program, and an interface for network connection. In addition, it will be understood by those skilled in the art that various modifications of the implementation method and the apparatus may be made.

In addition, a functional block diagram used to explain the present embodiment does not show a hardware-unit configuration but shows a block of functional units. Although each apparatus of the present embodiment is realized by one apparatus in these drawings, the implementation means is not limited to this. That is, a physically divided configuration or a logically divided configuration may also be adopted.

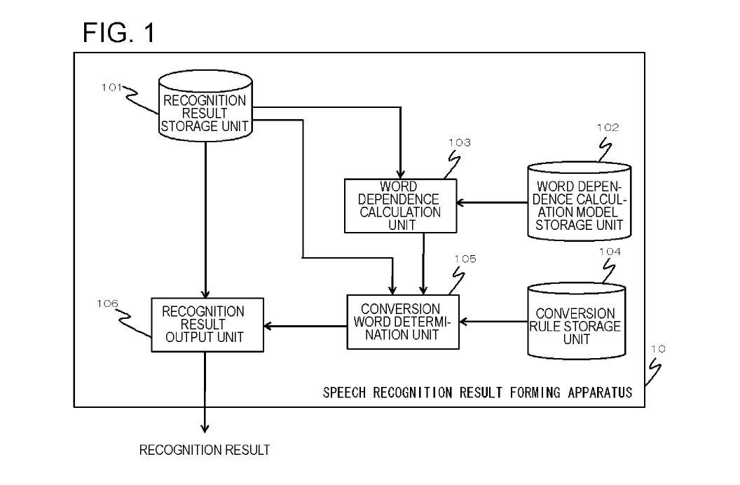

Referring to FIG. 1, a speech recognition result forming apparatus 10 of the present embodiment includes a recognition result storage unit 101, a word dependence calculation model storage unit 102, a word dependence calculation unit 103, a conversion rule storage unit 104, a conversion word determination unit 105, and a recognition result output unit 106. Hereinafter, each unit will be described.

The recognition result storage unit 101 stores recognition result data. The recognition result data includes character string data that is a speech recognition result (hereinafter, simply referred to as “character string data”). The character string data is divided into word strings (one or more words), and the recognition result confidence measure for speech recognition is given to each word string. In addition, the speech recognition result forming apparatus 10 may further include a speech recognition unit that acquires speech data and performs speech recognition (not shown in the drawings). In addition, the recognition result data generated by the speech recognition unit may be stored in the recognition result storage unit 101. The speech recognition unit may be realized according to the technique in the related art.

In addition, the recognition result storage unit 101 may further store morphological information of each word string or result information obtained by parsing the character string data, specifically, information indicating the result of decomposition of character string data into phrases, information indicating the modification relation of each phrase to other phrases, information indicating whether each word string is an independent word or an attached word, and the like. A computer can analyze such information automatically using the technique in the related art. The speech recognition result forming apparatus 10 may include a unit that analyzes such information (not shown in the drawings). When the character string data that is recognition result data is acquired, the unit may analyze the character string data automatically using the technique in the related art, and the analysis result may be stored in the recognition result storage unit 101.

The word dependence calculation model storage unit 102 stores information to determine the word dependence, which indicates the degree of connection with other word strings, for each word string. For example, the word dependence calculation model storage unit 102 may store a word dependence calculation model for calculating the word dependence obtained by quantifying the dependencies in the context between adjacent word strings. In addition, the word dependence calculation model storage unit 102 may store a word dependence calculation model for calculating the word dependence on the basis of the modification relation between phrases.

As the word dependence calculation model, for example, an identification model, a function based on the attributes of a word string, and the like may be considered. An example of the word dependence calculation model is shown below.

“Word dependence calculation model 1”: As an example, a model to calculate the word dependence on the basis of the attributes of a word string as in Expression 1 may be considered. That is, this is a model including a function of setting 1 when a certain word string Wi is an attached word and setting 0 when the word string Wi is an independent word.

$$f ( Wi ) = \{ \begin{matrix}1 \text{:} & if ( Wi is an attached work . ) \\ 0 \text{:} & otherwise\end{matrix} \qquad [ Expression 1 ]$$

“Word dependence calculation model 2”: As another example, a word dependence calculation model to calculate the word dependence on the basis of the presence or absence of a modified phrase may also be considered. For example, when there is a word string “soutei no han'i (range of assumption)”, “soutei no (of assumption)” is an adnominal modification phrase applied to “han'i (range)”. In this case, in this model, the word dependence of “no (of)” and “soutei (assumption)” is set to 0 since there is no modifying phrase (word string), and the word dependence of “han'i (range)” is set to 1 since there is a modifying phrase.

In the two examples described above, the word dependence has been expressed in two values (discrete values) of {0, 1}. However, it may also be considered to express the word dependence as a continuous value. For example, it may be considered to treat an identification model, such as a CRF (Non-patent Document 1). That is, by preparing programmable data to which a label, which indicates whether the word string is to be removed or replaced when the adjacent word string is removed, is given and learning the identification model, which has an expression of a word string, a part of speech, and the like as features, using the programmable data, a likelihood (probability) that the word string will be removed or replaced when the adjacent word string is removed or replaced can be calculated for each word string of the input text (recognition result).

The word dependence calculation unit 103 calculates a word dependence, which indicates the degree of connection with other word strings, for each word string included in the character string data. The word dependence calculation unit 103 calculates the word dependence of each word string with reference to the word dependence calculation model stored in the word dependence calculation model storage unit 102.

For example, when the word dependence calculation model is Expression 1 described above, the word dependence calculation unit 103 determines whether each word string is an independent word or an attached word, outputs 1 (word dependence) when each word string is an attached word and 0 (word dependence) when each word string is an independent word, and matches it with each word string. In addition, the word dependence calculation unit 103 determines, for each word string, whether there is a modifying phrase in a modification relation with a phrase including the word string, outputs 1 (word dependence) when there is a modifying phrase and 0 (word dependence) when there is no modifying phrase, and matches it with each word string. In this case, information that specifies the modifying phrase may be given to each word string. In addition, using the information stored in the recognition result storage unit 101, the word dependence calculation unit 103 can calculate word information, specifically, whether each word string is an independent word or an attached word, the modification relation of a phrase, and the like.

The conversion rule storage unit 104 stores a conversion rule that describes the rules to determine whether a word string is to be removed from the character string data or replaced with other data items. The conversion rule can be largely divided into two types.

“Conversion rule 1”: A low confidence measure word string, which is a word string whose recognition result confidence measure for speech recognition is lower than a predetermined value (design option), is removed from the character string data, which is recognition result data, or replaced with other data items. In addition, the recognition result confidence measure for speech recognition takes the value of 0 to 1, and an optimal value calculated in advance using other data items may be used as the predetermined value.

“Conversion rule 2”: When predetermined conditions are satisfied, word strings whose removal is to be considered, which are word strings located before and after a low confidence measure word string, are removed or replaced with other data items.

In addition, “located before and after the low confidence measure word string” means being located before and after a low confidence measure word string in the character string data.

The following rules may be considered as specific examples of the conversion rule 2.

“Conversion rule 2-1”: When the low confidence measure word string is an independent word, that is, when the word dependence is 1, if a word string whose removal is to be considered, which is located after the low confidence measure word string, is an attached word, the word string whose removal is to be considered is removed or replaced with other data items.

“Conversion rule 2-2”: When the low confidence measure word string is an attached word, that is, when the word dependence is 0, if a word string whose removal is to be considered, which is located before the low confidence measure word string, is an attached word string (string in which one or more attached words continue), the word string whose removal is to be considered is removed or replaced with other data items.

“Conversion rule 2-3”: When the low confidence measure word string is an attached word, that is, when the word dependence is 0, if a word string whose removal is to be considered, which is located after the low confidence measure word string, is an attached word string (string in which one or more attached words continue), the word string whose removal is to be considered is removed or replaced with other data items.

The above-described conversion rules 1, 2, and 2-1 to 2-3 are based on the assumption that the word dependence calculation model 1 is applied. When the word dependence calculation model 2 is applied, the conversion rules can be read as follows.

“Conversion rule 1′”: A phrase including a low confidence measure word string, which is a word string whose recognition result confidence measure for speech recognition is lower than a predetermined value (design option), is removed from the character string data, which is recognition result data, or replaced with other data items. In addition, the recognition result confidence measure for speech recognition takes the value of 0 to 1, and an optimal value calculated in advance using other data items may be used as the predetermined value.

“Conversion-rule 2′”: A word string included in a phrase, which modifies a phrase including a low confidence measure word string, is removed or replaced with other data items.

On the basis of the conversion rules stored in the conversion rule storage unit 104, the conversion word determination unit 105 determines whether a predetermined word string is to be removed from the character string data stored in the recognition result storage unit 101 or replaced with other data items. Specifically, this processing is performed in two steps.

First, the conversion word determination unit 105 performs processing of the following step 1.

“Step 1”: According to the conversion rule 1, a word string (low confidence measure word string) whose recognition result confidence measure for speech recognition is lower than a predetermined value (design option) is specified, and the low confidence measure word string is determined to be removed from the character string data or replaced with other data items.

For example, the conversion word determination unit 105 stores the above-described predetermined value in advance, and specifies a low confidence measure word string by comparing the size of the predetermined value with the size of the recognition result confidence measure for speech recognition given to each word string included in the character string data. Then, the conversion word determination unit 105 determines the specified low confidence measure word string to be removed from the character string data or replaced with other data items.

After the processing of step 1, the conversion word determination unit 105 performs processing of the following step 2.

“Step 2”: According to the conversion rule 2, when predetermined conditions are satisfied, word strings whose removal is to be considered, which are word strings located before and after a low confidence measure word string, are determined to be removed or replaced with other data items.

For example, the conversion word determination unit 105 determines from the word dependence whether the low confidence measure word string is an independent word or an attached word, and performs the following processing by applying the above-described conversion rule 2-1 when the low confidence measure word string is an independent word. That is, the conversion word determination unit 105 determines whether the word string whose removal is to be considered, which is located after the low confidence measure word string, is an attached word string, and determines the word string whose removal is to be considered to be removed or replaced with other data items when the word string whose removal is to be considered is an attached word string. In addition, when the word string whose removal is to be considered, which is located after the low confidence measure word string, is an independent word, the conversion word determination unit 105 determines the word string whose removal is to be considered to be left in the character string data as it is without removing the word string whose removal is to be considered or replacing the word string whose removal is to be considered with other data items. In addition, in this case, a word string whose removal is to be considered, which is located before the low confidence measure word string, is not to be processed. That is, the word string whose removal is to be considered, which is located before the low confidence measure word string, is left in the character string data as it is.

On the other hand, when the low confidence measure word string is an attached word string, the conversion word determination unit 105 performs the following processing by applying the above-described conversion rules 2-2 and 2-3. That is, the conversion word determination unit 105 determines whether each of the word strings whose removal is to be considered, which are located before and after the low confidence measure word string, is an attached word string, and determines the word string whose removal is to be considered to be removed or replaced with other data items when the word string whose removal is to be considered is an attached word string. In addition, when the word string whose removal is to be considered is an independent word, the conversion word determination unit 105 determines the word string whose removal is to be considered to be left in the character string data as it is without removing the word string whose removal is to be considered or replacing the word string whose removal is to be considered with other data items.

In addition, the above-described steps 1 and 2 are based on the assumption that the word dependence calculation model 1 is applied. When the word dependence calculation model 2 is applied, the conversion word determination unit 105 performs processing in the following two steps.

“Step 1′”: According to the conversion rule 1′, a phrase including a low confidence measure word string, which is a word string whose recognition result confidence measure for speech recognition is lower than a predetermined value (design option), is determined to be removed from the character string data, which is recognition result data, or replaced with other data items.

For example, the conversion word determination unit 105 stores the above-described predetermined value in advance, and specifies a low confidence measure word string by comparing the size of the predetermined value with the size of the recognition result confidence measure for speech recognition given to each word string included in the character string data. Then, the conversion word determination unit 105 specifies a phrase including the low confidence measure word string, and determines the specified phrase to be removed from the character string data or replaced with other data items.

After the processing of step 1′, the conversion word determination unit 105 performs processing of the following step 2′.

“Step 2′”: According to the conversion rule 2′, a word string included in a phrase, which modifies a phrase including a low confidence measure word string, is determined to be removed or replaced with other data items.

For example, the conversion word determination unit 105 specifies a phrase, which modifies a phrase including a low confidence measure word string, using the information stored in the recognition result storage unit 101, and determines a word string included in the phrase to be removed or replaced with other data items. In addition, the word string that is removed or replaced may be one or more words.

The recognition result output unit 106 generates preformatted character string data by removing the word string, which has been determined to be removed or replaced with other data items by the conversion word determination unit, from the character string data or replacing the word string with other data items on the basis of the character string data of recognition result data, and outputs the preformatted character string data as a speech recognition result of the speech data. In addition, replacement data, that is, data that is newly added to the character string data in place of a word string to be replaced may be one or more words, and may also be punctuation, symbols such as “*”, line feed, blank character, numbers, and the like.

An output unit as the recognition result output unit 106 is not particularly limited, and all output units, such as a display, a printer, and a speaker, can be used.

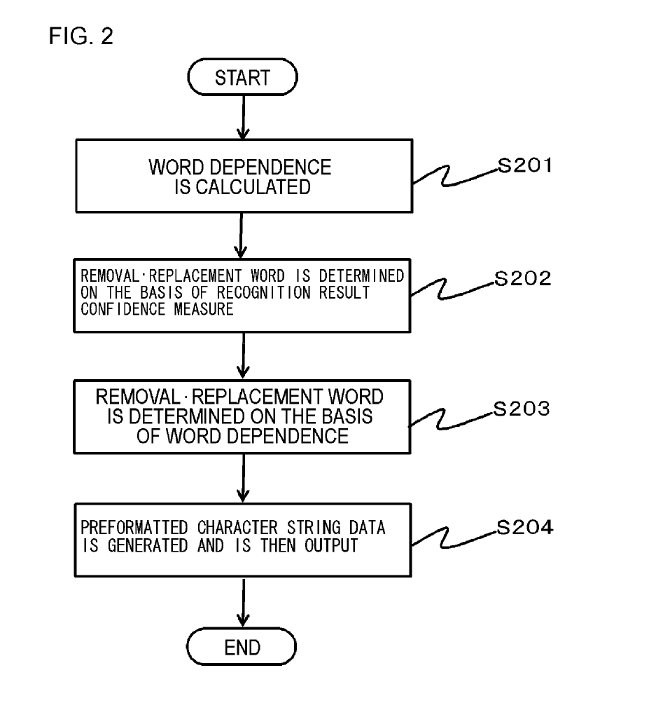

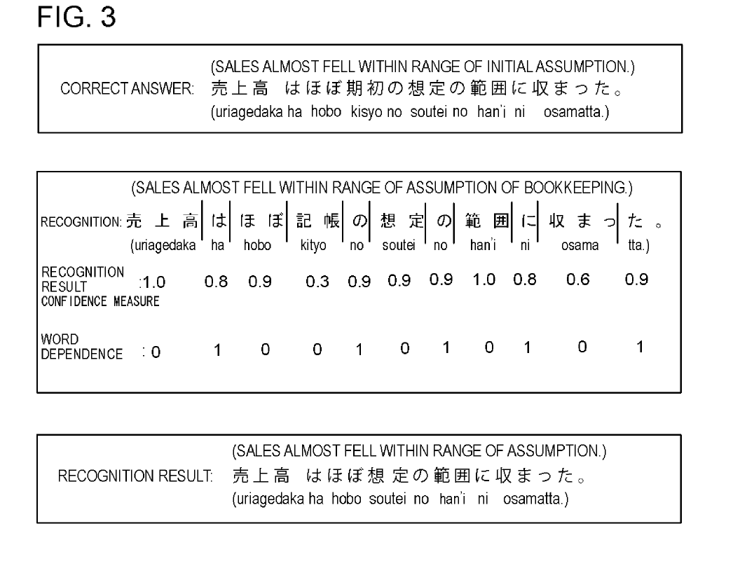

Next, an operation example of the present embodiment will be described with reference to FIGS. 2 and 3.

Here, the word dependence calculation unit 103 calculates the word dependence on the basis of the word dependence calculation model 1. In addition, the conversion word determination unit 105 executes predetermined processing on the basis of the conversion rules 1, 2, and 2-1 to 2-3.

In FIG. 3, a sentence shown as “recognition” is a result (character string data) of speech recognition of speech data of a sentence shown as “correct answer”. The character string data is divided into word strings as indicated by the vertical line.

If the sentences shown as “correct answer” and “recognition” in FIG. 3 are compared, it can be seen that “kisyo (initial)” has been incorrectly speech-recognized as “kityo (bookkeeping)”. In this case, the full sentence of the speech recognition result is “uriagedaka ha hobo kityo no soutei no han'i ni osamatta (Sales almost fell within the range of assumption of bookkeeping)”, which is a sentence that cannot be understood. According to the present embodiment, the character string data is formed as follows.

First, the word dependence calculation unit 103 calculates the word dependence on the basis of the word dependence calculation model 1 (S201 in FIG. 2).

Specifically, the word dependence calculation unit 103 determines whether each word string is an independent word or an attached word, and gives 1 to the word string when the word string is an attached word and 0 to the word string when the word string is an independent word. As a result, data of the word dependence is generated as shown in FIG. 3.

Then, the conversion word determination unit 105 specifies a word string (low confidence measure word string) whose recognition result confidence measure for speech recognition is lower than a predetermined value (design option) according to the conversion rule 1, and determines the low confidence measure word string to be removed from the character string data (S202 in FIG. 2).

Specifically, it is assumed herein that the conversion word determination unit 105 stores a predetermined value “0.5” in advance. The conversion word determination unit 105 compares the size of the predetermined value “0.5” with the size of the recognition result confidence measure for speech recognition given to each word string included in the character string data, and specifies “kityo (bookkeeping)” (recognition result confidence measure for speech recognition: 0.3), which has a recognition result confidence measure for speech recognition smaller than the predetermined value, as a low confidence measure word string. Then, the conversion word determination unit 105 determines “kityo (bookkeeping)”, which is a low confidence measure word string, to be removed from the character string data.

Then, according to the conversion rule 2, the conversion word determination unit 105 determines word strings whose removal is to be considered, which are word strings located before and after the low confidence measure word string, to be removed when predetermined conditions are satisfied (S203 in FIG. 2).

Specifically, the conversion word determination unit 105 refers to the word dependence of “kityo (bookkeeping)”, which is the low confidence measure word string, first. Here, since the word dependence of “kityo (bookkeeping)” is 1, the conversion word determination unit 105 determines that “kityo (bookkeeping)” is an “independent word”. Then, according to the conversion rule 2-1, the conversion word determination unit 105 determines whether the word string whose removal is to be considered “no (of)”, which is located after “kityo (bookkeeping)” (low confidence measure word string), is an attached word. Here, since the word dependence is 0, the conversion word determination unit 105 determines that the word string “no (of)” is an “attached word”. Then, according to the conversion rule 2-1, the conversion word determination unit 105 determines that the word string whose removal is to be considered “no (of)” is to be removed.

Then, the recognition result output unit 106 generates preformatted character string data by removing the word string, which has been determined to be removed by the conversion word determination unit 105 in steps S202 and S203 in FIG. 2, from the character string data and outputs the preformatted character string data (S204 in FIG. 2).

Specifically, the recognition result output unit 106 generates pre formatted character string data “uriagedaka ha hobo soutei no han'i ni osamatta (Sales almost fell within the range of assumption)” as shown as “recognition result” in FIG. 3 by removing “kityo (bookkeeping)” and “no (of)”, which have been determined to be removed by the conversion word determination unit 105, from the character string data “uriagedaka ha hobo soutei no han'i ni osamatta (Sales almost fell within the range of assumption of bookkeeping)”, which is shown as “recognition” in FIG. 3, and outputs the preformatted character string data.

Here, in S203, it is also possible to set word strings located before and after the word string whose removal is to be considered, which has been determined to be removed in S203, as new word strings whose removal is to be considered and to perform the same processing using the conversion rules 2 and 2-1 to 2-3. In addition, in this case, the wording of “low confidence measure word string” included in these conversion rules is replaced with “word string whose removal is to be considered that has been determined to be removed”.

Specifically, the conversion word determination unit 105 sets the word strings located before and after the word string whose removal is to be considered “no (of)”, which has been determined to be removed in the above S203, as new word strings whose removal is to be considered, and the conversion word determination unit 105 determines the word string whose removal is to be considered “no (of)” as an “attached word” first with reference to the word dependence of the word string whose removal is to be considered “no (of)” that has been determined to be removed in the above S203. Then, the conversion word determination unit 105 calculates the word dependence of the word string whose removal is to be considered “soutei (assumption)”, which is located after “no (of)”, according to the conversion rule 2-3, and the conversion word determination unit 105 determines that the word string whose removal is to be considered “soutei (assumption)” is an “independent word”. Then, according to the conversion rule 2-3, the conversion word determination unit 105 determines that the word string whose removal is to be considered “soutei (assumption)” is not to be removed. In addition, since the removal of “kityo (bookkeeping)”, which is located before the word string whose removal is to be considered “no (of)” that has been determined to be removed, has already been determined, “kityo (bookkeeping)” can be excluded from the word string whose removal is to be considered.

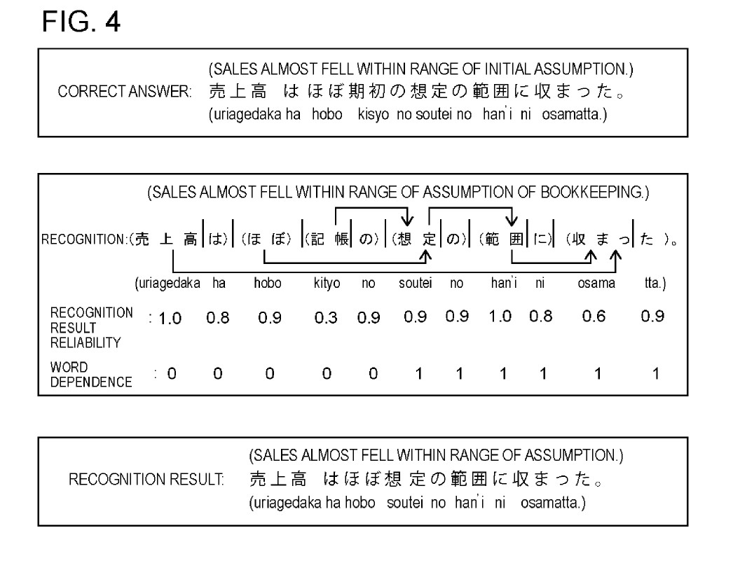

Next, another operation example of the present embodiment will be described with reference to FIG. 4.

Here, the word dependence calculation unit 103 calculates the word dependence on the basis of the word dependence calculation model 2. In addition, the conversion word determination unit 105 executes predetermined processing on the basis of the conversion rules 1′ and 2′.

In FIG. 4, a sentence shown as “recognition” is a result (character string data) of speech recognition of speech data of a sentence shown as “correct answer”. The character string data is divided into word strings as indicated by the vertical line. In addition, as shown in parentheses, the character string data is divided into phrases. In addition, as indicated by the arrows, the modification relation of phrases is shown. For example, it is shown that the phrase “uriagedaka ha (Sales)” modifies the phrase “osamatta (fell)”.

If the sentences shown as “correct answer” and “recognition” in FIG. 4 are compared, it can be seen that “kisyo (initial)” has been incorrectly speech-recognized as “kityo (bookkeeping)”. In this case, the full sentence of the speech recognition result is “uriagedaka ha hobo kityo no soutei no han'i ni osamatta (Sales almost fell within the range of assumption of bookkeeping)”, which is a sentence that cannot be understood. According to the present embodiment, the character string data is formed as follows.

First, the word dependence calculation unit 103 calculates the word dependence on the basis of the word dependence calculation model 2.

Specifically, the word dependence calculation unit 103 determines the presence or absence of a modifying phrase for each phrase, and sets the word dependence of a word string, which is included in the phrase having a modifying phrase, to 1 and sets the word dependence of a word string, which is included in the phrase having no modifying phrase, to 0. As a result, data of the word dependence is generated as shown in FIG. 4.

Then, the conversion word determination unit 105 specifies a word string (low confidence measure word string) whose recognition result confidence measure for speech recognition is lower than a predetermined value (design option) according to the conversion rule 1′, and determines a phrase including the low confidence measure word string to be removed from the character string data.

Specifically, it is assumed herein that the conversion word determination unit 105 stores a predetermined value “0.5” in advance. The conversion word determination unit 105 compares the size of the predetermined value “0.5” with the size of the recognition result confidence measure for speech recognition given to each word string included in the character string data, and specifies “kityo (bookkeeping)” (recognition result confidence measure for speech recognition: 0.3), which has a recognition result confidence measure for speech recognition smaller than the predetermined value, as a low confidence measure word string. Then, the conversion word determination unit 105 determines the phrase “kityo no (of bookkeeping)” including “kityo (bookkeeping)”, which is a low confidence measure word string, to be removed from the character string data.

Then, according to the conversion rule 2′, the conversion word determination unit 105 determines a word string included in the phrase, which modifies a phrase including the low confidence measure word string, to be removed.

Specifically, the conversion word determination unit 105 determines from the word dependence whether there is a phrase that modifies the phrase “kityo no (of bookkeeping)”. Here, since the word dependence of the phrase “kityo no (of bookkeeping)” is 0, there is no phrase that modifies this phrase. Therefore, the conversion word determination unit 105 determines that other phrases are not removed but left in the character string data as they are according to the conversion rule 2′.

Then, the recognition result output unit 106 generates preformatted character string data by removing the word string, which has been determined to be removed by the conversion word determination unit 105, from the character string data and outputs the preformatted character string data.

Specifically, the recognition result output unit 106 generates pre formatted character string data “uriagedaka ha hobo soutei no han'i ni osamatta (Sales almost fell within the range of assumption)” as shown as “recognition result” in FIG. 4 by removing the word string “kityo (bookkeeping)” and “no (of)”, which have been determined to be removed by the conversion word determination unit 105, from the character string data “uriagedaka ha hobo kityo no soutei no han'i ni osamatta (Sales almost fell within the range of assumption of bookkeeping)”, which is shown as “recognition” in FIG. 4, and outputs the preformatted character string data.

The present embodiment can also be similarly processed when the character string data which is recognition result data is English.

In addition, the speech recognition result forming apparatus of the present embodiment can be realized by installing the following program into a computer.

A program causing a computer to function as a recognition result output unit that refers to character string data, which is a speech recognition result, and removes a word string of a recognition error included in the character string data from the character string data and also, when attached word strings are located before and/or after the word string of the recognition error, generates preformatted character string data by removing at least one of the attached word strings from the character string data or replacing at least one of the attached word strings with other data items and outputs the preformatted character string data.

A program causing a computer to function as: a word dependence calculation unit that receives a recognition result and recognition result confidence measure for speech recognition and indicates dependencies in the context between adjacent word strings; a word dependence calculation model storage unit that stores a word dependence calculation model to calculate the word dependence; a conversion rule storage unit that describes the rule to convert a word string when removing or replacing the word string; and a conversion word determination unit that determines an output expression according to the recognition result confidence measure for speech recognition, the word dependence, and the conversion rule.

A program causing a computer to function as: a recognition result storage unit that stores character string data which is a speech recognition result; and a recognition result output unit that removes a word string of a recognition error included in the character string data from the character string data and, when attached word strings are located before and/or after the word string of the recognition error, generates preformatted character string data by removing at least one of the attached word strings from the character string data or replacing at least one of the attached word strings with other data items and outputs the preformatted character string data.

A program causing a computer to function as: a recognition result storage unit that stores recognition result data, which is character string data that is a speech recognition result and is divided into word strings and in which recognition result confidence measure for speech recognition is given to each word string; a conversion word determination unit that determines a low confidence measure word string, which is a word string whose recognition result confidence measure for speech recognition is lower than a predetermined value, to be removed from the character string data with reference to the recognition result data and also determines whether word strings whose removal is to be considered, which are word strings located before and after the word string, are to be removed from the character string data or replaced with other data items; and a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

A program causing a computer to function as: a recognition result storage unit that stores recognition result data, which is character string data that is a speech recognition result and is divided into word strings and in which recognition result confidence measure for speech recognition is given to each word string; a word dependence calculation unit that divides the character string data into phrases and determines a modification relation of each of the phrases to other phrases; a conversion word determination unit that determines a phrase including a low confidence measure word string, which is a word string whose recognition result confidence measure for speech recognition is lower than a predetermined value, to be removed from the character string data with reference to the recognition result data and also determines a word string included in a phrase, which is modified by the phrase, to be removed from the character string data or replaced with other data items with reference to the recognition result data; and a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

According to the speech recognition result forming apparatus, the speech recognition result forming method, and the program of the present embodiment, it is possible to appropriately form the character string data that is a speech recognition result. As a result, the character string data, which is a speech recognition result, can be converted into natural Japanese sentences.

In addition, according to the above explanation, the following explanation of the invention is also made.

<Invention 1>

A speech recognition result forming apparatus including: a recognition result storage unit that stores recognition result data, which is character string data that is a speech recognition result and is divided into word strings and in which recognition result confidence measure for speech recognition is given to each word string; a conversion word determination unit that determines a low confidence measure word string, which is a word string whose recognition result confidence measure for speech recognition is lower than a predetermined value, to be removed from the character string data with reference to the recognition result data and also determines whether word strings whose removal is to be considered, which are word strings located before and after the word string, are to be removed from the character string data or replaced with other data items; and a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

<Invention 2>

The speech recognition result forming apparatus described in Invention 1, which further includes a word dependence calculation unit that determines a word string dependence, which indicates a degree of connection with other word strings, for each word string included in the recognition result data and in which the conversion word determination unit determines whether the word strings whose removal is to be considered are to be removed or replaced with other data items using the word string dependence.

<Invention 3>

The speech recognition result forming apparatus described in Invention 2, in which the conversion word determination unit sets word strings located before and after the word string whose removal is to be considered, which has been determined to be removed or replaced with other data items, as new word strings whose removal is to be considered and determines whether the new word strings whose removal is to be considered are to be removed from the character string data or replaced with other data items.

<Invention 4>

The speech recognition result forming apparatus described in Invention 2 or 3, in which the word dependence calculation unit determines whether each word string is an independent word or an attached word, and the conversion word determination unit determines whether the word string whose removal is to be considered is to be removed or replaced with other data items on the basis of whether the low confidence measure word string is an independent word or an attached word and whether the word strings whose removal is to be considered, which are located before and after the low confidence measure word string, are independent words or attached words.

<Invention 5>

The speech recognition result forming apparatus described in Invention 4, in which the conversion word determination unit determines whether the word string whose removal is to be considered, which is located after the low confidence measure word string, is an attached word when the low confidence measure word string is an independent word and determines the word string whose removal is to be considered to be removed or replaced with other data items when the low confidence measure word string is an attached word.

<Invention 6>

The speech recognition result forming apparatus described in Invention 4 or 5, in which the conversion word determination unit determines whether the word strings whose removal is to be considered, which are located before and after the low confidence measure word string, are attached words when the low confidence measure word string is an attached word and determines the word strings whose removal is to be considered to be removed or replaced with other data items when the low confidence measure word string is an attached word.

<Invention 7>

A speech recognition result forming apparatus including: a recognition result storage unit that stores recognition result data, which is character string data that is a speech recognition result and is divided into word strings and in which recognition result confidence measure for speech recognition is given to each word string; a word dependence calculation unit that divides the character string data into phrases and determines a modification relation of each of the phrases to other phrases; a conversion word determination unit that determines a word string included in a phrase including a low confidence measure word string, which is a word string whose recognition result confidence measure for speech recognition is lower than a predetermined value, to be removed from the character string data with reference to the recognition result data and also determines a word string included in a phrase, which is modified by the phrase, to be removed from the character string data or replaced with other data items with reference to the recognition result data; and a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

<Invention 8>

A program causing a computer to function as: a recognition result storage unit that stores recognition result data, which is character string data that is a speech recognition result and is divided into word strings and in which recognition result confidence measure for speech recognition is given to each word string; a conversion word determination unit that determines a low confidence measure word string, which is a word string whose recognition result confidence measure for speech recognition is lower than a predetermined value, to be removed from the character string data with reference to the recognition result data and also determines whether word strings whose removal is to be considered, which are word strings located before and after the word string, are to be removed from the character string data or replaced with other data items; and a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

<Invention 9>

A program causing a computer to function as: a recognition result storage unit that stores recognition result data, which is character string data that is a speech recognition result and is divided into word strings and in which recognition result confidence measure for speech recognition is given to each word string; a word dependence calculation unit that divides the character string data into phrases and determines a modification relation of each of the phrases to other phrases; a conversion word determination unit that determines a phrase including a low confidence measure word string, which is a word string whose recognition result confidence measure for speech recognition is lower than a predetermined value, to be removed from the character string data with reference to the recognition result data and also determines a word string included in a phrase, which is modified by the phrase, to be removed from the character string data or replaced with other data items with reference to the recognition result data; and a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

<Invention 10>

A speech recognition result forming method causing a computer to execute: storing recognition result data, which is character string data that is a speech recognition result and is divided into word strings and in which recognition result confidence measure for speech recognition is given to each word string; a conversion word string determination step of determining a low confidence measure word string, which is a word string whose recognition result confidence measure for speech recognition is lower than a predetermined value, to be removed from the character string data with reference to the recognition result data and also determining whether word strings whose removal is to be considered, which are word strings located before and after the word string, are to be removed from the character string data or replaced with other data items; and a recognition result output step of generating preformatted character string data by removing a word string, which has been determined to be removed or replaced with other data items in the conversion word determination step, from the character string data or replacing the word string with other data items on the basis of the recognition result data and outputting the preformatted character string data as a speech recognition result of the speech data.

<Invention 11>

A speech recognition result forming method causing a computer to execute: storing recognition result data, which is character string data that is a speech recognition result and is divided into word strings and in which recognition result confidence measure for speech recognition is given to each word string; a word dependence calculation step of dividing the character string data into phrases and determining a modification relation of each of the phrases to other phrases; a conversion word determination step of determining a phrase including a low confidence measure word string, which is a word string whose recognition result confidence measure for speech recognition is lower than a predetermined value, to be removed from the character string data with reference to the recognition result data and also determining a word string included in a phrase, which is modified by the phrase, to be removed from the character string data or replaced with other data items with reference to the recognition result data; and a recognition result output step of generating preformatted character string data by removing a word string, which has been determined to be removed or replaced with other data items in the conversion word determination step, from the character string data or replacing the word string with other data items on the basis of the recognition result data and outputting the preformatted character string data as a speech recognition result of the speech data.

<Invention 12>

A speech recognition result forming apparatus including: a recognition result storage unit that stores character string data which is a speech recognition result; and a recognition result output unit that removes a word string of a recognition error included in the character string data from the character string data and, when attached word strings are located before and/or after the word string of the recognition error, generates preformatted character string data by removing at least one of the attached word strings from the character string data or replacing at least one of the attached word strings with other data items and outputs the preformatted character string data.

<Invention 13>

The speech recognition result forming apparatus described in Invention 12, in which the recognition result output unit outputs the preformatted character string data generated by removing an attached word string, which is located after the word string of the recognition error, from the character string data or replacing the attached word string with other data items when the word string of the recognition error is an independent word, and outputs the preformatted character string data generated by removing the attached word strings, which are located before and after the word string of the recognition error, from the character string data or replacing the attached word strings with other data items when the word string of the recognition error is an attached word.

<Invention 14>

The speech recognition result forming apparatus described in Invention 12 or 13, which further includes: a word dependence calculation unit that determines a word string dependence, which indicates a degree of connection with other word strings, for each word string included in the character string data; and a conversion word determination unit that determines whether word strings located before and after the word string of the recognition error are to be removed from the character string data or replaced with other data items using the word string dependence, and in which the recognition result output unit generates the preformatted character string data according to the determination result of the conversion word determination unit.

<Invention 15>

A program causing a computer to function as: a recognition result storage unit that stores character string data which is a speech recognition result; and a recognition result output unit that removes a word string of a recognition error included in the character string data from the character string data and also, when attached word strings are located before and/or after the word string of the recognition error, generates preformatted character string data by removing at least one of the attached word strings from the character string data or replacing at least one of the attached word strings with other data items and outputs the preformatted character string data.

<Invention 16>

A speech recognition result forming method including: causing a computer to perform processing for storing character string data, which is a speech recognition result, and removing a word string of a recognition error included in the character string data from the character string data and also, when attached word strings are located before and/or after the word string of the recognition error, generating preformatted character string data by removing at least one of the attached word strings from the character string data or replacing at least one of the attached word strings with other data items and outputting the preformatted character string data.

This application claims priority from Japanese Patent Application No. 2011-075257, filed on Mar. 30, 2011, the entire contents of which are incorporated herein.

1. A speech recognition result forming apparatus comprising:
a recognition result output unit that refers to character string data, which is a speech recognition result, and removes a word string of a recognition error included in the character string data from the character string data and also, when attached word strings are located before and/or after the word string of the recognition error, generates preformatted character string data by removing at least one of the attached word strings from the character string data or replacing at least one of the attached word strings with other data items and outputs the preformatted character string data.

2. The speech recognition result forming apparatus according to claim 1,
wherein, when the word string of the recognition error is an independent word, the recognition result output unit outputs the preformatted character string data generated by removing the attached word string, which is located after the word string of the recognition error, from the character string data or replacing the attached word string with other data items, and
when the word string of the recognition error is an attached word, the recognition result output unit outputs the preformatted character string data generated by removing the attached word strings, which are located before and after the word string of the recognition error, from the character string data or replacing the attached word strings with other data items.

3. The speech recognition result forming apparatus according to claim 1, further comprising:
a word dependence calculation unit that determines a word string dependence, which indicates a degree of connection with other word strings, for each word string included in the character string data; and
a conversion word determination unit that determines whether word strings located before and/or after the word string of the recognition error are to be removed from the character string data or replaced with other data items using the word string dependence,
wherein the recognition result output unit generates the preformatted character string data according to the determination result of the conversion word determination unit.

4. A non-transitory storage medium storing a program causing a computer to function as:
a recognition result output unit that refers to character string data, which is a speech recognition result, and removes a word string of a recognition error included in the character string data from the character string data and also, when attached word strings are located before and/or after the word string of the recognition error, generates preformatted character string data by removing at least one of the attached word strings from the character string data or replacing at least one of the attached word strings with other data items and outputs the preformatted character string data.

5. A speech recognition result forming method comprising:
causing a computer to execute processing for referring to character string data, which is a speech recognition result, and removing a word string of a recognition error included in the character string data from the character string data and also, when attached word strings are located before and/or after the word string of the recognition error, generating preformatted character string data by removing at least one of the attached word strings from the character string data or replacing at least one of the attached word strings with other data items and outputting the preformatted character string data.

6. A speech recognition result forming apparatus comprising:
a conversion word determination unit that refers to recognition result data, which is character string data that is a speech recognition result and is divided into word strings and in which recognition result confidence measure for speech recognition is given to each word string, and that determines a low confidence measure word string to be removed from the character string data on the basis of the recognition result confidence measure for speech recognition and also determines whether word strings whose removal is to be considered, which are word strings located before and after the low confidence measure word string, are to be removed from the character string data or replaced with other data items on the basis of the recognition result confidence measure for speech recognition; and
a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

7. The speech recognition result forming apparatus according to claim 6, further comprising:
a word dependence calculation unit that determines a word string dependence, which indicates a degree of connection with other word strings, for each word string included in the recognition result data,
wherein the conversion word determination unit determines whether the word strings whose removal is to be considered are to be removed or replaced with other data items using the word string dependence.

8. The speech recognition result forming apparatus according to claim 7,
wherein the conversion word determination unit determines whether the word string whose removal is to be considered, which is located after the low confidence measure word string, is an attached word when the low confidence measure word string is an independent word, and determines the word string whose removal is to be considered to be removed or replaced with other data items when the low confidence measure word string is an attached word.

9. The speech recognition result forming apparatus according to claim 7,
wherein the conversion word determination unit determines whether the word strings whose removal is to be considered, which are located before and after the low confidence measure word string, are attached words when the low confidence measure word string is an attached word, and determines the word strings whose removal is to be considered to be removed or replaced with other data items when the low confidence measure word string is an attached word.

10. A speech recognition result forming apparatus comprising:
a word dependence calculation unit that refers to recognition result data, which is character string data that is a speech recognition result and is divided into word strings and in which recognition result confidence measure for speech recognition is given to each word string, and that divides the character string data into phrases and determines a modification relation of each of the phrases to other phrases;
a conversion word determination unit that refers to the recognition result data and that determines a low confidence measure word string to be removed from the character string data and a phrase including the low confidence measure word string to be removed from the character string data on the basis of the recognition result confidence measure for speech recognition and also determines a phrase modified by the phrase to be removed from the character string data or replaced with other data items on the basis of the recognition result confidence measure for speech recognition; and
a recognition result output unit that generates preformatted character string data by removing a word string, which has been determined to be removed or replaced with other data items by the conversion word determination unit, from the character string data or replacing the word string with other data items on the basis of the recognition result data and outputs the preformatted character string data as a speech recognition result of the speech data.

11. The speech recognition result forming apparatus according to claim 2, further comprising:
a word dependence calculation unit that determines a word string dependence, which indicates a degree of connection with other word strings, for each word string included in the character string data; and
a conversion word determination unit that determines whether word strings located before and/or after the word string of the recognition error are to be removed from the character string data or replaced with other data items using the word string dependence,
wherein the recognition result output unit generates the preformatted character string data according to the determination result of the conversion word determination unit.

12. The speech recognition result forming apparatus according to claim 8,
wherein the conversion word determination unit determines whether the word strings whose removal is to be considered, which are located before and after the low confidence measure word string, are attached words when the low confidence measure word string is an attached word, and determines the word strings whose removal is to be considered to be removed or replaced with other data items when the low confidence measure word string is an attached word.
